(19) United States
(12) Patent Application Publication
(10) Pub. No.: US 2026/0155964 A1
(43) Pub. Date: Jun. 4, 2026

(54) SECURE 2NM SEMICONDUCTOR ARCHITECTURE WITH BACKSIDE POWER DELIVERY, RUTHENIUM INTERCONNECTS, AND ANALOG HARDWARE INTEGRITY MECHANISMS

(71) Applicant: Brian Terenna, Fort Myers, FL (US)

(72) Inventor: Brian Terenna, Fort Myers, FL (US)

(21) Appl. No.: 19/458,757

(22) Filed: Jan. 24, 2026

Related U.S. Application Data
(63) Continuation of application No. 19/452,335, filed on Jan. 18, 2026.

(51) Int. Cl. H04L 9/08

(52) U.S. Cl. CPC H04L 9/0861; H04L 9/088

(57) ABSTRACT

A system and method for hardware-interlocked identity succession utilize a hardware-rooted integrity sentinel and an analog audit engine to enforce state integrity in a 2 nm-class semiconductor. Voltage anomalies are detected via continuous-time monitoring using a differential propagation delay interferometer and an asynchronous glitch latch, and enforcement is applied by an analog impedance modulation network physically interposed on a processor signature-enable line. A vertical-stack inductive gradient sensor integrated within a BSPDN stack detects backside tamper via mutual inductance changes. An analog memristive crossbar audit engine performs stochastic challenge-response scoring, and a thermal-security via lattice stabilizes the audit engine while also providing a parallel discharge path for termination. Identity transfer is controlled by a hardware-interlocked state machine with a deadman timer that triggers zeroization absent a physical acknowledgment signal.

### CROSS-REFERENCE TO RELATED APPLICATIONS

This application is a continuation-in-part of U.S. Nonprovisional patent application Ser. No. 19/452,335, filed Jan. 18, 2026, titled “Hardware-Enforced Sovereign Economic Succession System (SESS) Utilizing Analog Semantic Gating and Atomic Succession Protocols,” the disclosure of which is incorporated herein by reference. This application claims the benefit of the foregoing application under 35 U.S.C. § 120 to the extent supported by the earlier-filed disclosure.

### BACKGROUND OF THE INVENTION

### Field of the Invention

The present invention relates generally to secure processor architectures and hardware-rooted integrity monitoring at the 2 nm technology node and beyond. More specifically, the invention relates to a system and method for verifiable state-integrity and identity succession utilizing a hardware-software hybrid architecture to provide an immutable governance layer anchored in a mixed-signal micro-architectural boundary, utilizing barrier-less Ruthenium interconnects and Backside Power Delivery Networks (BSPDN).

### Description of Related Art

The rapid proliferation of autonomous agentic entities has exposed an Autonomous Liability Gap in hardware infrastructure. Current Trusted Execution Environments (TEEs) utilize digital isolation mechanisms that are behaviorally blind and provide no hardware-imposed constraint on unauthorized state evolution once the execution layer is compromised.

Furthermore, current TEE architectures exhibit an analog observability deficit, remaining vulnerable to side-channel and fault-injection attacks that exploit nanosecond-scale physical voltage fluctuations and supply transients that are not visible to software sampling loops.

Existing migration frameworks rely on static attestation that confirms binary measurements but does not continuously constrain the physical integrity state of the execution substrate during state transfer. There exists a technical necessity for a system that perceives physical integrity through continuous asynchronous monitoring and enforces identity singularity through irreversible thermodynamic termination.

### BRIEF SUMMARY OF THE INVENTION

The present invention integrates a hardware-isolated governance layer directly into the processor substrate. The system anchors governance to the physical behavior of the integrated circuit, including current flow constraints and voltage-domain dominance, thereby maintaining enforcement independent of host software state.

The system comprises a deterministic state-integrity sentinel using mixed-signal pattern matching and an inductive coupling interdiction circuit. The sentinel compares V_core transient signatures against a provisioned voltage-profile manifest stored in a hardware overlay. The sentinel includes a continuous-time asynchronous glitch latch and a differential propagation delay interferometer sensitive to voltage transients exceeding a slew-rate threshold (e.g., ≥1 V/ns), thereby capturing nanosecond-scale anomalies that conventional sampling fails to detect. The foregoing slew-rate threshold and any accompanying numerical examples are illustrative and non-limiting; other thresholds may be selected consistent with detecting a physically anomalous transient on the monitored node.

Succession is gated by a succession audit engine using an analog memristor crossbar array to execute a proof-of-logical-alignment (PoLA) evaluation. To overcome analog noise, the engine employs a bit-slicing super-resolution architecture and a noise-adaptive threshold protocol. Multiple adversarial iterations are driven by a stochastic pulse generator comprising a metastable ring oscillator array sampled by asynchronous logic to yield a statistically aggregated alignment score.

The invention further comprises a disconnect-and-short sequence wherein a series-pass isolation switch decouples the core from external energy sources prior to activation of a crowbar MOSFET. The discharge path is implemented using a backside shunt network and a via-farm architecture that bounds peak current and distributes current density across a BSPDN structure. The system also executes asynchronous non-volatile memory (NVM) scrambling using hardware LFSR/XOR topology to render residual data forensically unrecoverable. The integrated sequence produces a hardware-defined thermodynamic termination state suitable for external verification.

### BRIEF DESCRIPTION OF THE DRAWINGS

FIG. 1 is a system block diagram illustrating a Host Operating System 100 coupled over an interconnect 102 to a Sovereign Wrapper 104, wherein the Sovereign Wrapper 104 encloses TEE-A 106, TEE-B 108, an OTP/fuse memory 110, a Genesis Boot Phase 112, and a Banker Enclave 114, and wherein the Sovereign Wrapper 104 is coupled to a secure provisioning facility 116.

FIG. 2 is a flowchart illustrating a secure provisioning and activation sequence for entering a sovereign state 216, including a power-on phase 202, a genesis authentication phase 204, establishment of a secure tunnel 206, manifest injection 208, and a hardware hash verify phase 210, wherein failure leads to an abort/zeroize path 212 and success leads to a commit policy path 214, and wherein a deadman timer 218 can force entry into the abort/zeroize path 212.

FIG. 3 is a system block diagram illustrating a Host Operating System 300 coupled over a System Interconnect/Fabric 302 to a Processor Die 304, wherein the Processor Die 304 implements a Sovereign Wrapper 316 enclosing TEE-A 306, TEE-B 308, a Banker Enclave 310, a Zeroization Engine 312, and an Interdiction Gate 314.

FIG. 4 is a schematic of an interdiction circuit in which upstream logic 402 drives a protected node 406 through an interdiction cell 404, the interdiction cell 404 being controlled by an interdiction control block 408 and referenced to a clamp reference 410.

FIG. 5 is a schematic of a PoLA analog front-end illustrating a Stochastic Pulse Generator 502 coupled to a Memristor Crossbar Array 504, a Wilson Current Mirror 506, a Resistive Compensation block 508, and a Summation Line 512.

FIG. 6 is a schematic of PoLA decision logic illustrating Subtract/Cancel circuitry 514, a Comparator Tree 516, and output nodes AUDIT_PASS, AUDIT_FAIL, and HANDSHAKE_OK derived from a summed current on the Summation Line 512.

FIG. 7 is a schematic of the Atomic Escape Pod illustrating the bifurcated signal path for CLK_KILL 602 and an engineered series-resistance element 616 configured for high-current discharge via the BSPDN shunt network 624, wherein the element 616 may include an optional distributed ballast segment in an alternate embodiment.

### DETAILED DESCRIPTION OF THE INVENTION

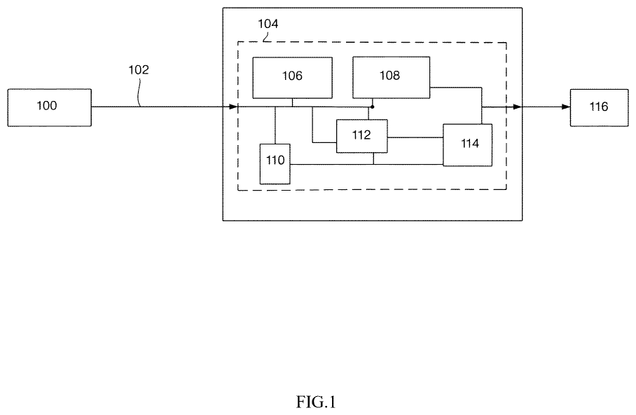

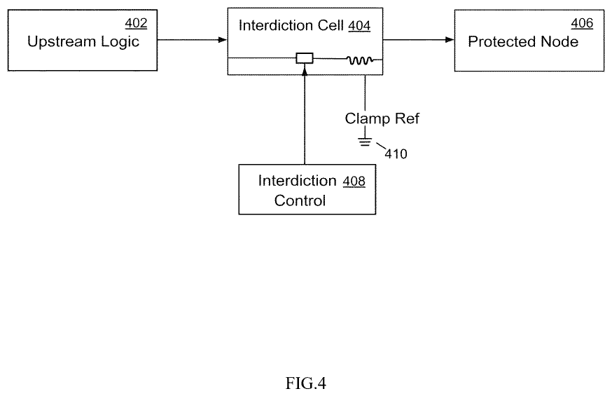

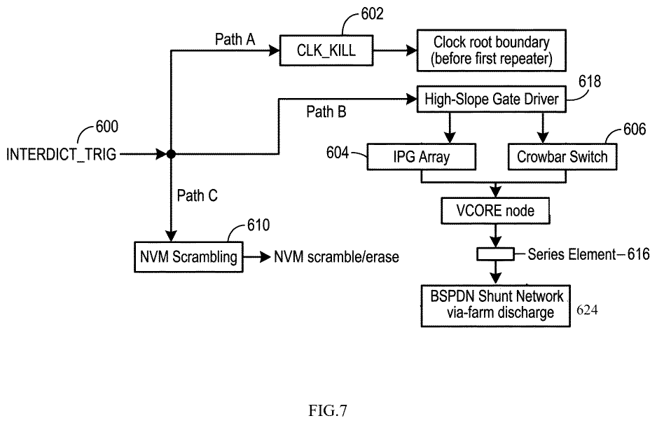

Referring to FIG. 1, the Sovereign Wrapper 104 represents a hardware encapsulation of a banking enclave and transaction assurance logic. The Sovereign Wrapper 104 comprises at least one trusted execution environment (TEE-A 106 and TEE-B 108), an OTP/fuse memory 110, and a Genesis Boot Phase 112 used to derive or unseal keys. The Sovereign Wrapper 104 further comprises a Banker Enclave 114 configured to accumulate and evaluate hardware-measured conditions and, upon meeting an interdiction threshold, to assert an interdiction trigger as a non-maskable, dedicated-metal control path to downstream interdiction circuitry (e.g., interdiction control 408 in FIG. 4 and/or INTERDICT_TRIG 600 in FIG. 7), thereby enabling state termination independent of host software.

[S-1: Vertical-Stack Inductive Gradient Sensor (VS-IGS)] The tamper-interdiction mechanism comprises a vertical-stack inductive gradient sensor integrated within the BSPDN stack. The circuit includes a primary inductor loop formed in a backside metal layer (M0_back) and a secondary inductor loop formed in a front-side metal layer (M0_front), separated by a dielectric spacer thickness t_spacer (e.g., t_spacer<10 nm). In one embodiment, the mutual inductance is modeled as M=k(t_spacer)·sqrt(L_primary·L_secondary), where the coupling coefficient k varies monotonically with t_spacer. A driver excites the primary loop with an AC excitation signal (e.g., at multi-GHz frequency) and a sensing circuit measures an amplitude and/or phase response at the secondary loop. Any backside polishing, delamination, or trenching that changes the dielectric spacer thickness by a small amount (e.g., ˜1 nm) produces a measurable shift in the response, which is compared against a threshold to assert INTERDICT_TRIG and thereby force termination. The foregoing spacer thicknesses, excitation frequencies, and coupling-model expressions are illustrative and non-limiting; other geometries, frequencies, and sensing modalities consistent with detecting a backside-induced inductive response change may be used.

[S-2: Analog Glitch Detection and Unified Interdiction Net] The device further comprises a voltage integrity sensor configured as a differential propagation delay interferometer. The sensor includes a reference delay path powered by a stabilized voltage domain and a sensitive delay path powered by the monitored rail. The sensitive delay path comprises an inverter chain using the Ruthenium interconnects described herein. A voltage transient alters propagation delay (t_pd) of the sensitive delay path, producing a phase error relative to the reference delay path. A phase detector asserts a hardware output when phase error exceeds a calibrated threshold. The phase detector output and the continuous-time asynchronous glitch latch are combined to form a unified interdiction net (INTERDICT_TRIG). INTERDICT_TRIG is physically realized through a plurality of distributed local interdiction cells rather than a single global wire, such that enforcement is generated within bounded placement regions associated with clock sectors. INTERDICT_TRIG is further combined via wired-OR/open-drain topology with (i) a Banker Enclave interdiction output and (ii) a PoLA audit fail output, and directly drives (a) a clock-kill driver controlling CLK_KILL 602 and (b) a high-slope gate driver 618 controlling the power isolation and crowbar sequence. The resulting interdiction path is a physically routed net that does not require software servicing or instruction retirement to propagate.

[R-1: Regionally Distributed Interdiction Cells (Local Clock Sectoring)] To avoid reliance on global-die propagation in advanced nodes, the integrated circuit is partitioned into a plurality of clock sectors. Each clock sector includes a local interdiction cell comprising: (i) a local sentinel front-end (glitch latch and/or interferometer tap), (ii) a local clock-kill gate element positioned at or before the first repeater stage of the sector clock distribution, and (iii) a local driver interface to the power isolation and crowbar control. Global coverage is achieved by replicating these local interdiction cells across the die. Each local cell is physically placed within a bounded radius of the protected logic and the sector clock root segment (e.g., ≤500 μm). The architecture thereby bounds the interdiction propagation path to a local, layout-controlled region rather than a global “furthest leaf” traversal.

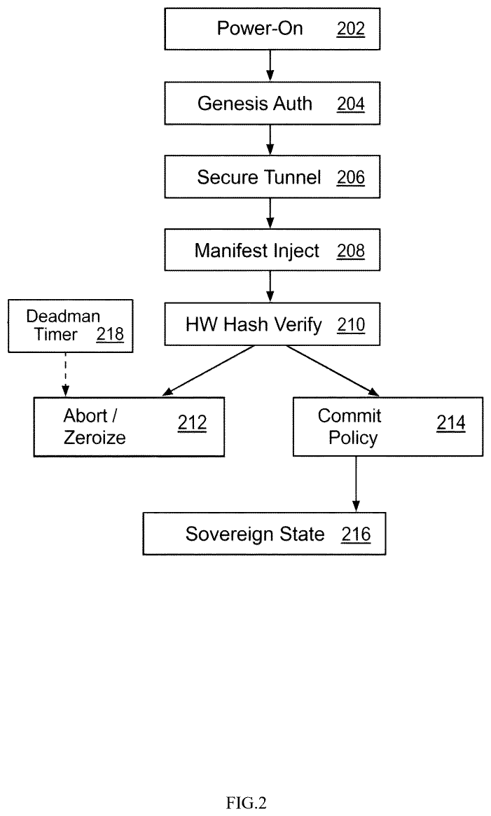

Referring to FIG. 2, the system establishes a root of trust through an enrollment flow starting with initiation/power-on 202 followed by authentication of the provisioning facility 116 via genesis path 204. The system establishes an isolated cryptographic tunnel 206 through which a policy manifest 208 is injected. Hardware-level hash verification 210 compares the received manifest signature against OTP memory 110. Failure asserts an abort and zeroize state 212; success commits policy 214 and asserts a sovereign operational state 216. During sovereign operational state, a machine identity key is derived using hardware KDF logic: IdentityKey=KDF(MRENCLAVE||Hash(System_Prompt)), where Hash(System_Prompt) is computed over the bitwise representation of the System_Prompt data structure. Any bitwise mismatch between the stored hash and the recomputed hash asserts a hardware invalidate signal that prevents use of IdentityKey and causes the interdiction net to be asserted, thereby binding identity validity to deterministic data-structure integrity rather than semantics. As used herein, the “Sovereign Operational State” refers to a hardware-verified electrical configuration defined by simultaneous satisfaction of (i) irreversible programming of a provisioned genesis indicator in OTP memory 110 and (ii) continuous assertion of a HASH_MATCH signal from the hardware comparator verifying the boot-time policy manifest against the OTP signature. Entry into this state disables external debug paths (e.g., JTAG) and enables the governance overlay, including the analog veto and interdiction networks. The state persists until a power-on reset or a termination/zeroize event clears volatile state. [DEF-0: Definitions and Implementation Notes] Terms such as “sovereign,” “governance,” “thermodynamic,” and “alignment” are used herein as descriptive labels for particular hardware-enforced electrical configurations and circuit behaviors. Patentability and claim scope rely on the disclosed circuit structures, their interconnections, placement constraints, and measurable operating bounds (e.g., voltage thresholds, resistance windows, via counts, and timing closure), and not on policy objectives or semantic intent.

[M-1: Metallization Enablement] The interconnect structure operates within a resistivity crossover regime defined by a metal pitch of less than 24 nm. Within this regime, interconnect lines comprise Ruthenium (Ru) formed via subtractive etch or semi-damascene. Unlike copper metallization requiring a diffusion barrier occupying substantial trench volume at these dimensions, Ruthenium interconnects are disposed in a barrier-less configuration adjacent to the inter-layer dielectric (ILD). In one embodiment, with line width w between 8 nm and 14 nm, the Ruthenium lines maintain an effective resistivity (ρ_eff) below approximately 35 μΩ·cm within the resistivity crossover regime. In one embodiment, scattering behavior may be modeled using an effective mean free path on the order of several nanometers (e.g., λ_Ru≈6.6 nm), and the Ruthenium microstructure may be configured to reduce grain boundary scattering (e.g., a grain boundary reflection coefficient R less than approximately 0.5 in a representative model). These numerical values are provided as non-limiting examples; other values consistent with the described resistivity crossover regime may be used.

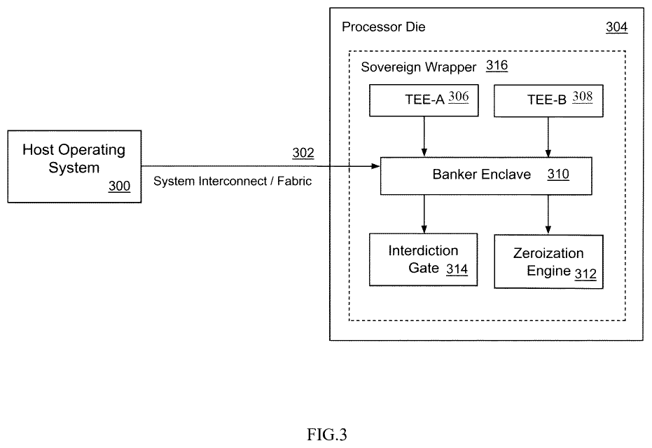

Referring to FIG. 3, the Host Operating System 300 communicates over the System Interconnect/Fabric 302 with the Processor Die 304. The Processor Die 304 implements the Sovereign Wrapper 316 that encloses TEE-A 306 and TEE-B 308 coupled to the Banker Enclave 310. The Banker Enclave 310 is further coupled to the Interdiction Gate 314 and the Zeroization Engine 312. In response to an interdiction condition detected within the Sovereign Wrapper 316, the Banker Enclave 310 drives the Interdiction Gate 314 to isolate or suppress downstream activity and drives the Zeroization Engine 312 to initiate irreversible state termination and/or key erasure.

[S-3: Hardware-Interlocked Key Transport and Termination Arming] In one embodiment, identity succession occurs between a first TEE (TEE_A 106) and a second TEE (TEE_B 108). A PoLA handshake is executed by presenting a set of challenge vectors (including stochastic challenge-response cycles) to the audit engine, producing an aggregated alignment score and asserting HANDSHAKE_OK only when the score satisfies a hardware-defined threshold. Key transport is implemented as a hardware-interlocked sequence controlled by a state machine. When a transfer is initiated, an ARMED latch is set and a countdown timer begins, the timer being clocked by an independent oscillator (e.g., a ring oscillator distinct from the protected clock domain). A key export gate remains disabled unless both (i) HANDSHAKE_OK is asserted and (ii) a transfer-complete signal TRANSFER_DONE from a DMA/write path is asserted. Acknowledgment that TEE_B has received and stored the migrated key is represented as a dedicated hardware acknowledgment signal (ACK_IN) observed on a physical wire/pin or on-die interconnect, rather than a software message. The state machine clears ARMED only upon observing ACK_IN within the timer window; if the timer expires while ARMED remains set, the state machine directly asserts INTERDICT_TRIG to trigger the zeroization/termination sequence. In this manner, termination arming is conditioned on physical acknowledgment and is not dependent on software policy evaluation.

Referring to FIG. 4, the interdiction cell 404 provides a hardware-enforced analog suppression path between upstream logic 402 and the protected node 406. In some embodiments, the interdiction cell 404 comprises a controllable series impedance and/or an open-drain clamp device referenced to the clamp reference 410. The interdiction control 408 drives the interdiction cell 404 to either (i) present a substantially low-impedance clamp of the protected node 406 toward the clamp reference 410 or (ii) insert an effective impedance that inhibits propagation of upstream switching into the protected node 406, thereby achieving signal-level interdiction independent of host software.

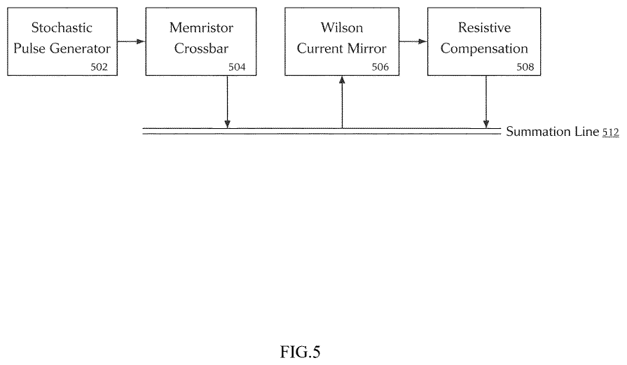

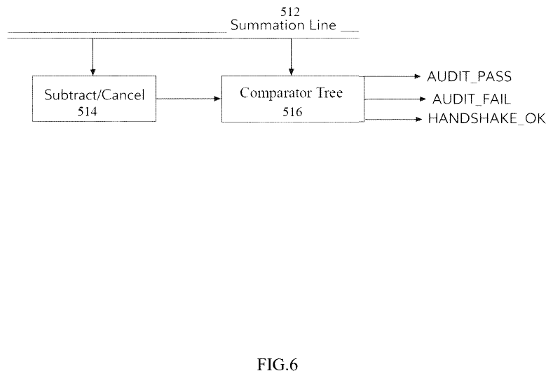

Referring to FIGS. 5 and 6, the PoLA audit engine performs a behavioral audit via an analog memristor crossbar array 504 that produces a current-mode dot-product on a summation line 512. Input challenge vectors are driven into row/column interfaces of the crossbar array 504, and the resulting aggregate current on the summation line 512 is presented to a hardware comparator tree. A stochastic pulse generator 502 provides adversarial challenge timing and vector selection; in one embodiment the generator comprises a metastable ring-oscillator array sampled by asynchronous elements (e.g., metastability-hardened flip-flops and/or Muller C-elements) followed by de-bias logic (e.g., Von Neumann corrector) to produce a conditioned challenge stream. To isolate the summation node from downstream loading and to replicate the summation current for redundant comparison, the engine includes a Wilson current mirror 506 coupled to the summation line 512. A resistive compensation network 508 is coupled within the mirror/summation loop to damp parasitic pole/zero interactions associated with BEOL resistance and crossbar capacitance, such that small-signal stability is maintained with a phase margin of at least 60° over process/voltage/temperature corners. In this topology, the PoLA decision is produced as a binary AUDIT_PASS or AUDIT_FAIL signal by the comparator tree based on whether the mirrored and/or direct summation currents exceed a hardware-defined threshold window. Stability targets such as phase margin values are illustrative and non-limiting; other compensation approaches and stability margins may be used consistent with reliable comparator decisioning under expected process-voltage-temperature variation. In embodiments, the decision logic includes Subtract/Cancel circuitry 514 and a Comparator Tree 516 that generate AUDIT_PASS, AUDIT_FAIL, and HANDSHAKE_OK signals, as shown in FIG. 6.

[A-1: Thermal-Security Nexus] The integrated circuit comprises a thermal-security nexus wherein an analog memristive crossbar array is fabricated in the BEOL stack and vertically aligned with a backside via population that is electrically coupled to the termination shunt network. During nominal operation, the via population functions as a localized heat extraction structure maintaining the memristive layer within a bounded thermal envelope by providing a thermal conduction path to a backside heat spreader or package interface. The via population can comprise refractory conductors (e.g., Ruthenium and/or Tungsten) and can be deployed at high density (e.g., >10\hat{ }4 vias in a local region). During a termination event, the same via population participates as a via farm that partitions discharge current into parallel paths, thereby reducing per-via current density while realizing an engineered effective resistance (e.g., R_eff in the milliohm range) that bounds I_peak for a specified capacitance and supply voltage. In this manner, a single microstructure provides both thermal stabilization for the analog audit engine and a high-current discharge path for thermodynamic termination.

[A-2: Analog Precision] The analog computing engine executes cryptographic and alignment-relevant comparisons using a bit-slicing super-resolution architecture. High-precision weights (e.g., 8-bit or 16-bit) are decomposed into lower-precision slices stored across parallel memristive cells. Analog current outputs are aggregated via weighted summation and digitized by an ADC that may employ redundant-column averaging. The architecture thereby achieves an effective number of bits exceeding approximately 6 bits for aggregate operations despite device variability. The foregoing precision metrics and any example ENOB values are illustrative and non-limiting; other bit-slicing factors and precision targets may be used consistent with the disclosed aggregation-based super-resolution.

[P-1: Stochastic Pulse Generator (502) Topology] The stochastic pulse generator 502 comprises a plurality of metastable ring oscillators arranged as an array. Outputs of the oscillators are sampled by asynchronous sampling elements such as metastability-hardened flip-flops or Muller C-elements to capture thermal and jitter-derived entropy. In one embodiment, the sampled bitstream is conditioned by de-biasing logic such as Von Neumann correctors and monitored by online health tests that detect stuck-at behavior and entropy collapse. The conditioned output drives generation of synthetic transactional prompts and challenge vectors used by the PoLA handshake iterations.

[D-1: Hierarchical Interleaved TDM-S/H Driver for Crossbar Loading] To load high-dimensional vectors into a large memristor array (e.g., 4,096 rows), the system utilizes a hierarchical interleaved time-division multiplexed sample-and-hold (TDM-S/H) driver. In one embodiment, the array is partitioned into 64 sub-arrays of 64 rows each and driven by 64 sub-rate DAC cores, each DAC core driving a distinct 64-row sub-array through a local sample-and-hold capacitor bank. Pre-charge buffers charge the hold capacitors toward a coarse estimate during a preceding interval, reducing the required slew and settling burden during the active drive interval. For a concrete example, an aggregate row-update cadence on the order of 1 GHz corresponds to each of the 64 DAC cores operating at approximately 15.6 MHz (1 GHz/64). This interleave provides an effective per-sub-array settling window that can exceed tens of nanoseconds; in one engineered embodiment the hold capacitors are allocated an effective settling window of at least 20 ns to meet a 12-bit-equivalent settling target at the crossbar input nodes. During operation, one sub-array is actively driven by the fine DAC output while the remaining sub-arrays retain their last-driven values on the hold capacitors, thereby maintaining a quasi-static analog vector across the full crossbar during each audit interval. This frequency example is illustrative and non-limiting.

Referring to FIG. 7, interdiction response logic may be initiated by assertion of INTERDICT_TRIG 600. Path A asserts CLK_KILL 602 to suppress clock propagation at a clock-root boundary prior to the first repeater stage. Path B configures a high-slope gate driver 618 to rapidly enable a high-current discharge path. In some embodiments, the discharge path includes an engineered series element 616 coupled to a BSPDN shunt network 624 configured for via-farm discharge. Path C triggers asynchronous NVM scrambling 610 comprising a hardware LFSR and a parallel bank of XOR gates that execute a bitwise transformation of target NVM contents in a bounded number of cycles (including a single-cycle embodiment for narrow-word NVM regions).

[T-1: Thermodynamic Enablement of 200A-Class Discharge] To mitigate self-heating in advanced Gate-All-Around (GAA) transistor architectures and to enable controlled high-current discharge without vaporization, the backside structure includes a via population and a refractory redistribution network that together implement an engineered effective series resistance R_eff. A first via population (“thermal vias”) may be implemented as nano-through-silicon vias (nTSVs) having diameter between 20 nm and 50 nm, depth between 200 nm and 350 nm, and pitch between 100 nm and 200 nm for thermal extraction. A second via population (“discharge via farm”) is electrically coupled to the crowbar return path and is sized for current distribution during a discharge event, such that the peak current is divided among a large number of parallel vertical conductors (e.g., N_discharge≥10\hat{ }4 participating vias within a bounded region). The via farm is coupled to a backside refractory metal redistribution layer comprising materials such as tungsten, ruthenium, cobalt, or combinations thereof, the layer having thickness and width selected to provide (i) a dominant conductive cross-section for lateral current spreading and (ii) thermal mass for transient energy absorption. For example, the backside redistribution layer may be approximately 1-2 μm thick and extend laterally across tens to hundreds of micrometers (covering the via farm region), providing a cross-sectional area on the order of 10\hat{ }4 μm\hat{ }2 for current conduction and heat spreading. In one embodiment, the backside redistribution layer and the discharge via farm are thermally coupled to a backside heat spreader and/or package interface such that the same conductors providing current spreading also provide a transient heat egress path during termination events. Any via dimensions, pitches, and conductor counts described herein are illustrative and non-limiting; other geometries and counts may be selected consistent with distributing discharge current and achieving the described termination behavior.

In one embodiment, R_eff is intentionally engineered to be in the milliohm range (e.g., 3 mΩ to 10 mΩ, including an example of about 5 mΩ) to avoid the parasitic-only regime (<1 mΩ) that would otherwise permit destructive peak currents. For a core voltage near 1 V, an engineered R_eff of about 5 mΩ bounds I_peak near 200 A (I_peak≈V_core/R_eff). The effective discharge energy is bounded by the capacitance that remains coupled to the core rail after isolation, defined as C_eff, which includes on-die decoupling capacitance and any package capacitance remaining inside the isolation boundary (e.g., C_eff from tens of nF up to several μF depending on the isolation switch placement). The energy available for discharge is approximately E≈½·C_eff·V_core², and the transient energy dissipated in the shunt network is additionally bounded by the discharge interval during which IV and I²R losses occur. The backside refractory redistribution layer and substrate interface are configured to absorb this transient energy without localized melting, while the via farm partitions current density to remain below electromigration and fusing thresholds for the selected conductors. The foregoing current and resistance values are illustrative and non-limiting.

In one embodiment, the IPG array 604 comprises a plurality of parallel power-gate cells (e.g., n≥1000) to distribute current density during isolation transitions and to present an aggregate on-resistance in the low-milliohm range. The crowbar MOSFET 606 is sized and routed to the BSPDN shunt such that the crowbar return path is dominated by the engineered R_eff and the backside redistribution cross-section rather than by fragile front-side polysilicon or minimum-pitch local interconnect.

[V-1: Timing Verification and Local Sector Latency] To enable sub-cycle interdiction, the design mandates post-layout parasitic extraction (LPE) of the interdiction nets and the local clock-kill root segments for each clock sector implementing an interdiction cell. LPE extracts R_trace, C_coupling, and via parasitics for INTERDICT_TRIG, CLK_KILL control routing, and the local clock gating insertion point. Simulation verifies that the worst-case detection-to-clock-kill gate delay within the local clock sector is less than the setup-time slack of the protected logic stage or less than one clock period for the sector clock, including process/voltage/temperature corners. Critical interdiction nets may be routed on dedicated top-level metals and may include inverter repeaters to maintain edge rate; however, the architecture does not rely on a single interdiction signal traversing the global die.

[E-1: Alternate Embodiments and Fail-Safe Interlocks] The embodiments may be complemented or substituted by alternative designs. The isolation switch may be implemented with front-side metallization or conventional TSV-based power interrupts where backside delivery is unavailable. Redundant interlocks may include an independent ring-oscillator watchdog operating on a separate bias domain; if the primary clock deviates beyond tolerance or halts unexpectedly, the watchdog asserts an interdiction output that wires into INTERDICT_TRIG. Additional alternative interdiction implementations include: (i) clock stretching by analog bias injection into a local DLL/PLL control node to arrest timing closure, and (ii) inductive or capacitive coupling of interdiction energy into a dedicated kill net routed in a shielded metal layer. In an optional alternate embodiment, a distributed ballast resistance is selectively insertable in series with the discharge path to bound di/dt and peak current for specific operating modes; for example, a gated ballast segment (e.g., 10 mΩ to 200 mΩ implemented as a widened silicided polysilicon strap or a dedicated refractory-metal meander) may be switched into the discharge path by a bypass transistor. In this optional mode, the primary high-speed termination embodiment (milliohm-range engineered R_eff with via-farm current partitioning) remains available by enabling the bypass transistor to short the ballast segment, while the ballast-inserted mode provides a slower, current-limited discharge profile for events where reduced electromagnetic/thermal shock is preferred.

[T-2: Worked Example—200A Termination Event] In an example design scenario, let the effective remaining capacitance after isolation be C_eff=50 nF and the core voltage V_core=1.0 V. Upon a tamper or fail event, the energy available for discharge is approximately E=½·C_eff·V_core²≈25 nJ. With the engineered R_eff set to about 5 mΩ (within the disclosed 3-10 mΩ range), the initial peak discharge current would be on the order of I_peak≈V_core/R_eff=200 A. This current rapidly decays as the charge is dissipated; the R_eff·C_eff time constant in this example is 5×10\hat{ }−3 Ω·50×10\hat{ }−9 F=250×10\hat{ }−12 s, so the high-current pulse lasts on the order of only a few hundred picoseconds (sub-nanosecond scale) before dropping off. Crucially, the discharge via farm (≥10\hat{ }4 parallel nTSVs) partitions the 200 A surge so that each individual via carries on the order of only 0.02 A. Such a current per via is well below electromigration and fusing limits for a nano-scale TSV over a sub-ns interval. The backside refractory metal layer (e.g., tungsten or cobalt), having a volume on the order of 10\hat{ }−8 cm\hat{ }3 in the vicinity of the discharge region, possesses sufficient thermal mass to absorb the ˜25 nJ discharge energy with a negligible temperature rise (estimated <<1° C.). Thus, in this worked example, the device safely executes a thermodynamic termination: the core rail is quickly pulled to ground potential through a broadly distributed network, avoiding localized hot spots or physical damage while irreversibly zeroing out the volatile state. This worked example is illustrative and non-limiting.

[V-2: Sub-Cycle Interdiction Timing Assurance] Consider a protected clock domain operating at 2 GHz (a 0.5 ns clock period). The disclosed architecture achieves sub-cycle response by placing interdiction cells within a bounded physical distance (e.g., ≤500 μm) of the protected logic and by inserting the clock-kill gate at or before the first repeater stage of the local clock sector. Post-layout parasitic extraction (LPE) and timing verification are performed on the routed INTERDICT_TRIG and CLK_KILL nets to bound propagation delay plus gate latency below one cycle of the protected clock. In one embodiment, the architecture relies on local-sector interdiction rather than a global “furthest leaf” guarantee, thereby avoiding dependence on a global clock tree timing bound. This timing example is illustrative and non-limiting.

[A-3: Analog Audit Engine Accuracy and Noise Mitigation] Analog computing elements at advanced nodes require circuit structures to maintain precision under device variability and thermal noise. The specification accordingly discloses structural features to ensure the memristor crossbar PoLA audit engine produces repeatable AUDIT_PASS/AUDIT_FAIL results. In one embodiment, crossbar output columns terminate into a summation line (e.g., 512) buffered by a current-domain interface such as a Wilson current mirror 506, and stabilized by a resistive compensation network 508 that provides a defined phase margin (e.g., ≥60°). Super-resolution can be obtained via bit-slicing of weights across multiple devices per logical weight and by aggregating multiple challenge-response iterations. To mitigate sneak-path and leakage variability, the crossbar includes a noise-floor monitor column programmed to a known reference conductance state (e.g., a “zero” column). A comparator tree derives decision thresholds using a reference proportional to the measured monitor-column current I_noise, and subtracts (or cancels) an estimate of I_noise from the active summation current I_sum prior to thresholding, such that I_result≈I_sum−I_noise. This differential cancellation provides improved effective precision and repeatability for audit scoring across temperature and process variation.

[ADV-1: Technical Improvements and Advantages] The disclosed system provides concrete improvements to computer security and functionality by physically enforcing integrity constraints that were previously unenforceable in real-time. For example, the interdiction cell 404, under control of the interdiction control 408, establishes hardware voltage dominance over a protected node 406 by clamping the protected node 406 toward a clamp reference 410, ensuring that no malicious software action can override the hardware-imposed suppression state. This eliminates an entire class of analog blind-spot attacks (such as subtle power glitch-induced authority escapes) that software-based monitors cannot catch. The distributed clock sectoring and local kill-net insertion reduce enforcement latency to the point of bounding unauthorized computation to a small bounded window, improving determinism and secure processor behavior. Further, the engineered discharge path that includes an effective series resistance and a BSPDN shunt network 624 enables controlled high-current termination while limiting peak current and containing transient energy during a zeroization event, reducing risk of physical damage while irreversibly erasing volatile secrets. Unlike an abstract policy check, these mechanisms alter the device's physical state (voltage, current flow, and timing) in carefully designed ways to improve security. In sum, by rooting enforcement in hardware down to the substrate level, the invention improves the functioning of the computing device itself by converting what would otherwise be an abstract security policy into circuit-level actions that guarantee termination of a compromised execution state.

What is claimed is:

1. A secure semiconductor apparatus comprising:
(a) a processor die including a substrate region containing a trusted execution environment (TEE) execution layer;
(b) an analog impedance modulation device physically interposed on a processor signature-enable line, the device comprising an open-drain transistor and a series-resistance bottleneck fabricated as a thin-film Ruthenium resistor, the open-drain transistor being configured to establish a voltage-divider ratio with a digital driver such that, during interdiction, a node voltage on the signature-enable line is forced below a logic-low threshold voltage V_IL(max) by a design margin δ, and optionally clamped to approximately 0.2×V_DD, regardless of a software-driven state of the digital driver, wherein the series-resistance bottleneck is selected to bound contention current density and self-heating while maintaining said node voltage below V_IL(max) during a sustained drive-fight state;
(c) a hardware-isolated sentinel circuit comprising (i) a continuous-time asynchronous glitch latch and (ii) a differential propagation delay interferometer powered by a monitored rail, the glitch latch and interferometer being configured to assert an interdiction trigger in response to a voltage transient of the monitored rail exceeding a slew-rate threshold;
(d) a succession audit engine comprising an analog memristor crossbar array storing bit-sliced weight segments, a summation line producing an analog summation current, a Wilson current mirror coupled to the summation line to replicate the summation current, and a hardware comparator tree configured to generate an AUDIT_PASS signal or an AUDIT_FAIL signal from the summation current or a mirrored version thereof;
(e) an interdiction net comprising a wired-OR/open-drain topology combining (i) an output of the sentinel circuit, (ii) an audit fail output of the succession audit engine, and (iii) an optional banker enclave output, the interdiction net being coupled to a clock-kill gate element of a clock distribution network within each clock sector to disable clock propagation in response to assertion of the interdiction net; and
(f) a thermodynamic zeroization circuit comprising a series-pass isolation switch and a crowbar transistor coupled to a backside shunt network including a discharge via farm, the circuit being configured, upon assertion of the interdiction net, to decouple a core power rail from an external supply and to short the core power rail to a ground return through the backside shunt network.

2. The apparatus of claim 1, wherein the series-resistance bottleneck comprises a barrier-less thin-film Ruthenium resistor segment fabricated in a resistivity crossover regime defined by a metal pitch of less than 24 nanometers and a line width between 8 nm and 14 nm, the resistor segment being selected to provide a predictable sheet resistance density that mitigates electromigration drift during a sustained drive-fight state while maintaining the voltage-divider ratio that forces the node voltage below V_IL(max).

3. The apparatus of claim 1, wherein the backside structure comprises nano-through-silicon vias (nTSVs) having a diameter between 20 nm and 50 nm and a pitch between 100 nm and 200 nm configured for thermal extraction, and further comprises the discharge via farm electrically coupled to a crowbar return path and configured to distribute a discharge current across at least 10\hat{ }4 parallel vertical conductors.

4. The apparatus of claim 1, further comprising an inductive coupling interdiction sensor comprising a primary inductor formed in a backside metal layer and a secondary inductor formed in a front-side metal layer separated by a dielectric spacer having a thickness less than 10 nm, wherein a change in mutual inductance causes an induced electromotive force that triggers a destructive element to sever a buried power rail connection.

5. The apparatus of claim 1, wherein the succession audit engine decomposes high-precision weights into multiple lower-precision segments stored across parallel memristive cells and aggregates analog outputs via weighted summation and digitization to achieve an effective number of bits exceeding 6 bits for an aggregate matrix operation.

6. The apparatus of claim 1, further comprising a banker enclave comprising a synchronous hardware accumulator physically tied to the analog impedance modulation network via a dedicated non-maskable DC-coupled metal trace absent intervening clocked registers.

7. The apparatus of claim 1, wherein the engineered effective series resistance R_eff is in a range of about 3 milliohms to about 10 milliohms to bound peak discharge current during a termination event.

8. The apparatus of claim 1, wherein an interdiction control node is embedded within the physical silicon substrate to maintain structural independence from the TEE execution layer.

9. The apparatus of claim 1, wherein the series-pass isolation switch comprises an integrated power-gate (IPG) array having at least 1000 parallel power-gate cells providing an aggregate on-resistance in a low-milliohm range.

10. The apparatus of claim 1, further comprising a redundant watchdog circuit including a ring oscillator on an independent bias domain, the watchdog circuit being configured to assert an interdiction output into the interdiction net if a primary clock deviates beyond a tolerance or halts unexpectedly.

11. The apparatus of claim 1, further comprising a non-volatile memory scrambling engine comprising a linear-feedback shift register (LFSR) and a bank of XOR gates, the scrambling engine being configured to irreversibly randomize contents of a protected non-volatile memory upon initiation of the thermodynamic zeroization circuit.

12. A method for hardware-interlocked identity succession utilizing the apparatus of claim 1, the method comprising:
(a) monitoring a physical integrity state via the sentinel circuit;
(b) asserting the interdiction trigger via the interferometer or glitch latch upon detecting the voltage transient;
(c) clamping a signature-enable line within one clock cycle by enabling an analog impedance modulation device to impose a bounded series impedance between upstream logic and a protected node;
(d) executing stochastic challenge-response cycles by generating, via the stochastic pulse generator, a sequence of challenge vectors; applying corresponding voltage pulses to the analog memristor crossbar to produce a column summation current on a summation line; differentially cancelling a leakage/noise-floor current measured from a monitor column; and comparing the resulting current against a hardware-defined threshold via the comparator tree to assert a HANDSHAKE_OK signal;
(e) enabling an on-die key-wrapping datapath to transfer identity key material to a second trusted execution environment only when HANDSHAKE_OK is asserted and a hardware transfer-complete signal is observed; and
(f) arming a hardware deadman switch coupled to a termination-control input, wherein expiration of a hardware countdown timer while the deadman switch is armed asserts the interdiction net and triggers the thermodynamic zeroization circuit.

13. The method of claim 12, wherein transferring the identity key material comprises deriving a migration key using a key derivation function on a concatenation of a code measurement of a first TEE (MRENCLAVE) and a cryptographic hash of a system prompt data structure.

14. The apparatus of claim 1, wherein the succession audit engine further comprises a Wilson current mirror coupled to a summation line of the analog memristor crossbar array and a resistive compensation network configured to provide a phase margin of at least 60 degrees for a feedback loop associated with the summation line.

15. The apparatus of claim 1, further comprising a hierarchical interleaved time-division multiplexed sample-and-hold driver having a plurality of sub-rate digital-to-analog converter cores and sample-and-hold capacitors configured to load analog vectors into rows of the analog memristor crossbar array in an interleaved schedule.

16. The apparatus of claim 2, wherein the Ruthenium resistor segment is configured such that, at a line width between 8 nm and 14 nm, an effective resistivity is maintained below approximately 35 μΩ·cm.

17. The apparatus of claim 1, wherein the succession audit engine further comprises a noise floor monitor column within the analog memristor crossbar array, the monitor column being programmed to a reference conductance state, and wherein the hardware comparator tree subtracts a monitor-column current from a summation-line current prior to asserting the audit pass signal or the audit fail signal.

18. The apparatus of claim 1, wherein the local clock-kill insertion point is located at or before a first clock repeater stage within a clock sector and the local interdiction cell is placed within 500 μm of a sector clock root segment.

19. The method of claim 12, wherein clamping the signature-enable line within one clock cycle comprises routing at least a portion of the interdiction net on a dedicated top-level metal layer and verifying, via post-layout parasitic extraction, that a worst-case detection-to-clock-kill gate latency is less than a clock period of a protected clock sector.

20. The apparatus of claim 1, wherein the interdiction net is physically realized through a plurality of distributed local interdiction cells each associated with a respective clock sector, each local interdiction cell comprising (i) a local sentinel front-end configured to assert a local interdiction signal and (ii) a local clock-kill gate element positioned at or before a first repeater stage of a sector clock distribution, such that interdiction is generated within a bounded, layout-controlled placement region rather than requiring a single interdiction signal to traverse the global die.
